(19) United States
(12) Patent Application Publication
(10) Pub. No.: US 2012/0281729 A1
(43) Pub. Date: Nov. 8, 2012

(54) ENVIRONMENT SENSITIVE DEVICES

(75) Inventors: Fung Suong Ou, Mountain View, CA (US); Zhiyong Li, Redwood City, CA (US); Huei Pei Kuo, Cupertino, CA (US); Min Hu, Sunnyvale, CA (US)

(73) Assignee: HEWLETT PACKARD DEVELOPMENT COMPANY, L.P., Houston, TX (US)

(21) Appl. No.: 13/387,075

(22) PCT Filed: Jan. 29, 2010
(86) PCT No.: PCT/US2010/022562

§ 371 Date: Jan. 25, 2012

(51) Int. Cl. G01K 5/48; B44C 1/22

(52) U.S. Cl. 374/187; 216/41; 374/E05.03

(57) ABSTRACT

An environment sensitive device is disclosed. The device includes a substrate, a three-dimensional structure established on the substrate, a first coating established on a first portion of the three-dimensional structure, and a second coating established on a second portion of the three-dimensional structure. The first and second coatings contain different materials that are configured to respond differently when exposed to a predetermined external stimulus.

### STATEMENT REGARDING FEDERALLY SPONSORED RESEARCH OR DEVELOPMENT

This invention was made in the course of research partially supported by grants from the Defense Advanced Research Projects Agency (DARPA), Contract No. HR0011-09-3-0002. The U.S. government has certain rights in the invention.

### BACKGROUND

The present disclosure relates generally to environment sensitive devices.

Sensing devices often incorporate nanostructures which are utilized for detecting changes in electrical and/or mechanical properties of the nanostructure when an analyte is on or near the nanostructure, or for altering optical signals emitted by an analyte when the analyte is on or near the nanostructure and is exposed to photons. Sensing devices may utilize different sensing techniques, including, for example, transduction of adsorption and/or desorption of the analytes into a readable signal, spectroscopic techniques, or other suitable techniques.

Raman spectroscopy is one useful technique for a variety of chemical or biological sensing applications. Raman spectroscopy is used to study the transitions between molecular energy states when photons interact with molecules, which results in the energy of the scattered photons being shifted. The Raman scattering of a molecule can be seen as two processes. The molecule, which is at a certain energy state, is first excited into another (either virtual or real) energy state by the incident photons, which is ordinarily in the optical frequency domain. The excited molecule then radiates as a dipole source under the influence of the environment in which it sits at a frequency that may be relatively low (i.e., Stokes scattering), or that may be relatively high (i.e., anti-Stokes scattering) compared to the excitation photons. The Raman spectrum of different molecules or matters has characteristic peaks that can be used to identify the species. Rough metal surfaces, various types of nano-antennas, as well as waveguiding structures have been used to enhance the Raman scattering processes (i.e., the excitation and/or radiation process described above). This field is generally known as surface enhanced Raman spectroscopy (SERS).

### BRIEF DESCRIPTION OF THE DRAWINGS

Features and advantages of examples of the claimed subject matter will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1 is a flow diagram of an example of a method for forming an example of an environment sensitive device;

FIGS. 2A through 2I are schematic views which together illustrate an example of the method for forming an example of the environment sensitive device;

FIGS. 3A and 3B are scanning electron micrographs of different cone-shaped structures;

FIGS. 4A, 4B, and 4C are schematic perspective views of various examples of the environment sensitive devices; and

FIGS. 5A, 5B, and 5C together illustrate a schematic view of an example of a system including an example of the environment sensitive device, and also illustrate how the device responds differently to a different external stimulus.

### DETAILED DESCRIPTION

Examples of environment sensitive devices are disclosed herein. Such devices include one or more three-dimensional structures, each having two different coatings thereon. Such coatings are selected to respond differently to different external stimuli. As a result, the position of the three-dimensional structures can be controlled during SERS applications depending upon the external stimulus to which they are exposed. The ability to control the position of the individual structures also advantageously contributes to the ability to control the angle of the incident laser with respect to the surface of the structures during SERS applications.

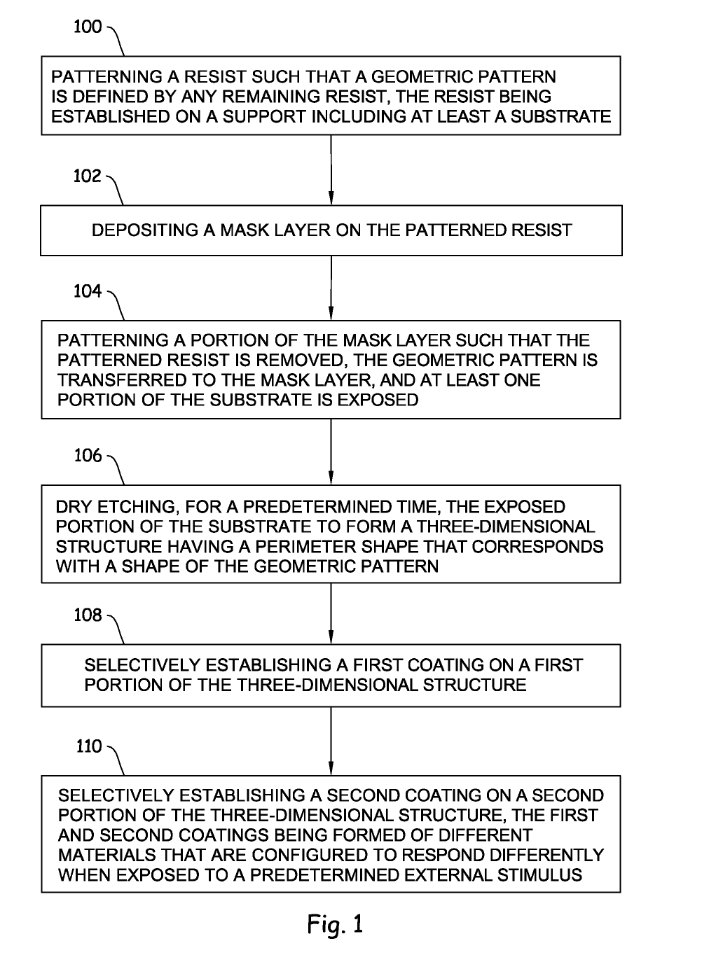

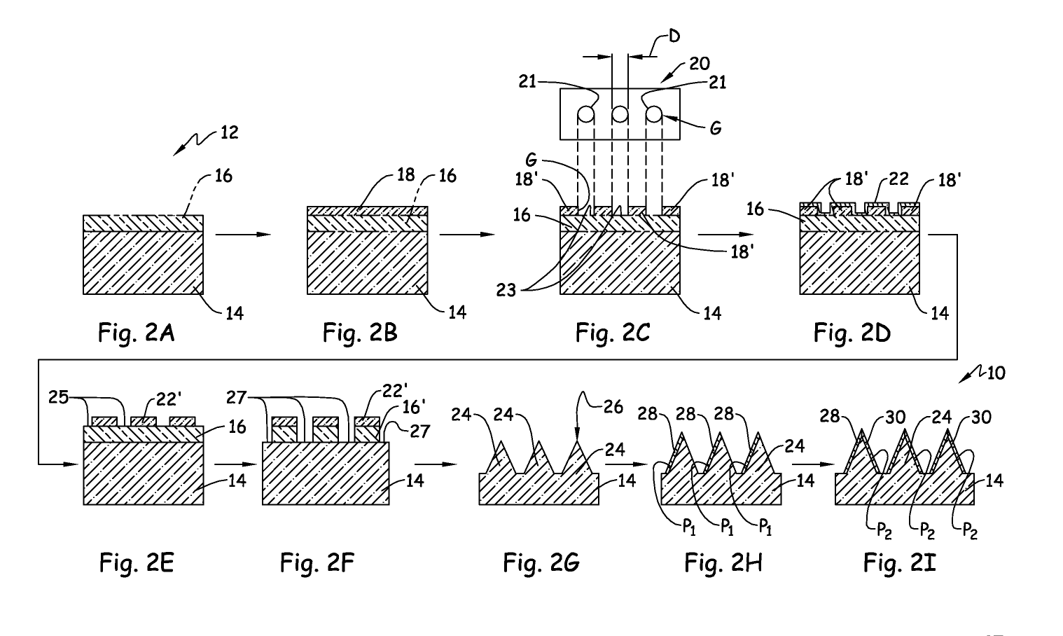

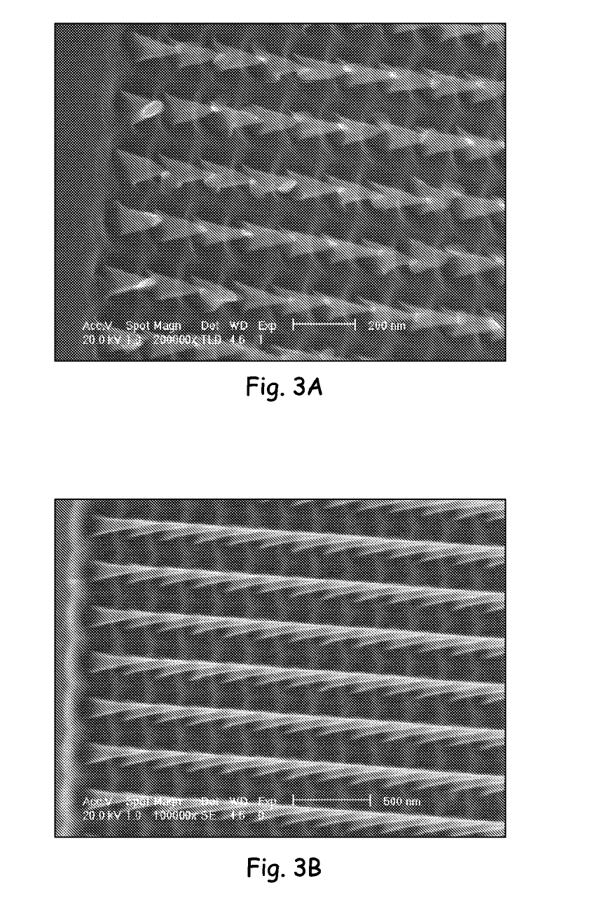

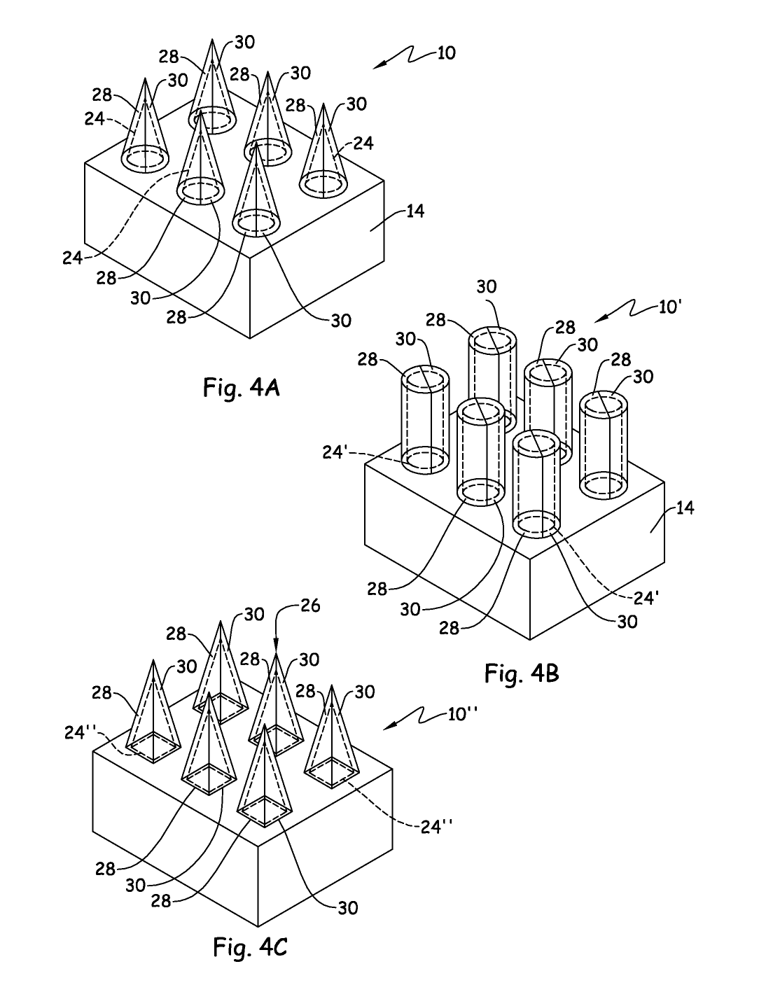

FIG. 1 illustrates an embodiment of a method for forming an embodiment of an environment sensitive device. The steps of the method shown in FIG. 1 will be discussed in further detail herein with reference to FIGS. 2A through 2I. In particular, FIGS. 2A through 2I illustrate an embodiment of the method for forming a device including a cone-shaped structure. More generally, the three-dimensional structures may be any three-dimensional geometric shape that has a round or polygon perimeter base, or that tapers from a round or polygon perimeter base to a sharper tip (e.g., an apex or vertex). The shape depends upon the pattern used and the etching conditions during formation of the device. Non-limiting examples of three-dimensional shapes include cones, cylinders, or polygons having at least three facets that meet at a tip (e.g., a pyramid), or the like. As used herein, the terms “cone-shaped” or “cone shape” describe a protrusion having a three-dimensional geometric shape that tapers from a round perimeter base to a sharp tip (e.g., an apex or vertex). Examples of the cone-shaped structures are shown in FIGS. 3A, 3B, and 4A. Still further, as used herein, the terms “cylinder-shaped” or “cylinder shape” describe a protrusion having a substantially consistent perimeter from the base to the tip (see, e.g., FIG. 4B); and the terms “polygon-shaped” or “polygon shape” describe a protrusion having three or more facets that taper from a polygon perimeter base to a sharp tip (see, e.g., FIG. 4C).

The embodiment of the method for forming the environment sensitive device including the cone-shaped three-dimensional structures will now be discussed in reference to FIGS. 1 and 2A through 2I. While the method illustrated in FIGS. 2A through 2I results in the formation of three structures, it is to be understood that a single structure may be formed, or an array including more than three structures may be formed. The upper limit of how many structures may be formed depends, at least in part, upon the size of the substrate used, the pattern used, and the fabrication process used. Generally, the embodiments disclosed herein may be scaled up as is desirable for a particular end use.

As shown in FIG. 2A, a support 12 is illustrated. In one embodiment, the support 12 includes a substrate 14. Non-limiting examples of suitable substrate 14 materials include single crystalline silicon, polymeric materials (acrylics, polycarbonates, polydimethylsiloxane (PDMS), polyimides, poly(acetylene)s, poly(pyrrole)s, poly(thiophene)s, polyanilines, poly(p-phenylene sulfide), and poly(para-phenylene vinylene)s (PPV), etc.), metals (aluminum, copper, stainless steel, alloys, etc.), quartz, ceramic, sapphire, silicon nitride, glass, silicon-on-insulators (SOI), or diamond like carbon films.

In another embodiment (as shown in FIG. 2A), the support 12 may include the substrate 14 having an insulating layer 16 established thereon. Any suitable insulating material may be used for the insulating layer 16. In a non-limiting example embodiment, the insulating layer 16 is an oxide (e.g., silicon dioxide). Non-limiting examples of other suitable materials for the insulating layer 16 include nitrides (e.g., silicon nitride), oxynitrides, or the like, or combinations thereof. The insulating layer 16 may be established using any suitable growth or deposition technique. A thermal oxide insulator layer may be formed by the partial oxidation of silicon (e.g., the substrate 14), which forms silicon dioxide on the silicon. Various oxide and nitride materials may be established via deposition techniques which include, but are not limited to low-pressure chemical vapor deposition (LPCVD), plasma enhanced chemical vapor deposition (PECVD), atmospheric pressure chemical vapor deposition (APCVD), or any other suitable chemical or physical vapor deposition techniques. In one embodiment, the thickness of the insulating layer is 100 nm. In one embodiment, the thickness ranges from about 10 nm to about 3 μm.

It is to be understood that while the method shown in FIGS. 2A through 2I includes the insulating layer 16, the process may be performed without such layer 16. The process would be substantially the same, except that any steps involving patterning and/or removal of the insulating layer 16, 16′ would be eliminated. As an example, the patterning of the insulating layer 16 shown and discussed in reference to FIG. 2F would not be performed.

FIG. 2B illustrates a resist 18 established on the insulating layer 16. When the insulating layer 16 is not utilized, the resist 18 is established directly on the substrate 14. A non-limiting example of a suitable resist 18 is polymethyl methacrylate (PMMA). It is to be understood, however, that any material that can act as an electron-beam (E-beam) or x-ray lithography resist may be utilized for resist 18. Further, the resist 18 may be deposited via any suitable method, such as, for example, via spin coating. In an embodiment, the thickness of the resist 18 ranges from about 10 nm to about 3 μm.

As set forth at reference numeral 100 of FIG. 1 and as illustrated in FIG. 2C, a mask 20, having one or more geometric patterns G integrally formed therein, is used in conjunction with electron beam (e-beam) or x-ray lithography to pattern the resist 18 such that any remaining resist 18′ defines the geometric pattern(s) G. In one embodiment, the mask 20 is configured such that the geometric pattern G is transferred to the portion of the resist 18 that is removed after patterning is complete (i.e., the remaining portion does not take on the geometric pattern G itself, but rather defines the pattern G). The mask 20 shown in FIG. 2C (which is rotated to facilitate understanding of the patterns G) may be used to form three circular shapes in the resist 18. It is to be understood that after patterning, portions of the insulating layer 16 (or substrate 14, if insulating layer 16 is not present) are exposed, and such exposed portions 23 resemble the geometric patterns G.

The geometric pattern G may be any shape (e.g., circle, oval, square, triangle, rectangle, pentagon, etc.). The outer edge 21 of each geometric pattern G substantially dictates the perimeter shape of a corresponding ultimately formed three-dimensional structure. By “substantially dictates”, it is meant that the shape of the outer edge 21 of the geometric pattern G matches the shape of the base of the three-dimensional structure, taking into account minor variations resulting from etching or other processing conditions.

The dimensions of each geometric pattern G may vary, depending at least in part, on the desirable shape for the final three-dimensional structures. In one embodiment, the geometric pattern G is a circle having a diameter D that is equal to or less than 200 nm. In another embodiment, the geometric pattern G is a circle having a diameter D that ranges from about 100 nm to about 200 nm. In still another embodiment, the geometric pattern G is a circle having a diameter D that ranges from about 10 nm to about 1000 nm. It is to be understood that any number or range within the stated ranges is also contemplated as being suitable for the embodiments disclosed herein. Furthermore, the numbers and ranges provided for the diameter D may also be suitable for one or more dimensions of the outer edge 21 of the other geometries (e.g., each side of the outer edge 21 of a square geometric pattern).

Referring now to FIG. 2D and reference numeral 102 of FIG. 1, a mask layer 22 is established on the patterned resist 18′ and on the exposed portions 23 of the insulating layer 16. When the insulating layer 16 is not utilized, it is to be understood that the mask layer 22 is established on the patterned resist 18′ and on the exposed portions of the substrate 14. A non-limiting example of the mask layer 22 is chromium or any other metal. The thickness of the mask layer 22 generally ranges from about 10 nm to about 300 nm, and the mask layer 22 may be established via any suitable technique, such as sputtering, e-beam lithography, or thermal evaporation.

The established mask layer 22 may then be patterned to remove those portions of the mask layer 22 established on the patterned resist 18′, and the underlying patterned resist 18′ (see reference numeral 104 of FIG. 1 and FIG. 2E). This patterning step transfers the geometric pattern G (or a slightly smaller shape resembling the geometric pattern G) to the mask layer 22. As illustrated in FIG. 2E, the patterned mask layer 22′ itself takes on the geometry of the pattern G. This step forms patterned mask layer 22′, and also exposes other portions 25 of the insulating layer 16 (or substrate 14 when the insulating layer 16 is not present).

Still referring to reference numeral 104 of FIG. 1, but now also referring to FIG. 2F, the other exposed portions 25 of the insulting layer 16 (i.e., those portions that are exposed as a result of the mask layer 22 being patterned) are now patterned. This patterning step transfers the geometric pattern G (or a slightly smaller shape resembling the geometric pattern G) to the insulating layer 16. As illustrated in FIG. 2F, both the patterned mask layer 22′ and the patterned insulating layer 16′ have the geometric patterns G transferred thereto. This step forms patterned insulating layer 16′, and also exposes portions 27 of the substrate 14. As previously mentioned, if the insulating layer 16 is not present, the patterning step shown in FIG. 2F is not performed.

When the insulating layer 16 is used, both the mask layer 22 and the insulating layer 16 may be patterned via lift-off processes. While the patterning of the layers 22 and 16 is shown as a sequential process, it is to be understood that these layers 16, 22 may also be patterned simultaneously.

FIG. 2G illustrates the formation of the cone-shaped three-dimensional structures 24. As depicted at reference numeral 106, the portion of the substrate 14 underlying the exposed portions 27 are dry etched (e.g., via HBr etching or any other reactive ion etching process). During etching, the patterned mask layer 22′, and when present insulating layer 16′, is/are consumed and the cone shape structures 24 are formed in the substrate 14. The desired cone-shaped structure 24 may be achieved when the geometric pattern G is circular and has a desirable diameter D, and when the etch time is controlled to correspond with the dimensions of the geometric pattern G. As such, the starting dimensions of the geometric pattern G dictates, at least in part, the etch time used to form the desired three-dimensional structure (in this example the cone-shaped base structure 24) in the substrate 14. As one non-limiting example, when a 100 nm diameter circular pattern is used, etching is accomplished for about 2.5 minutes to achieve the cone-shaped structures 24. Cone-shaped structures 24 formed using the 100 nm circular pattern and 2.5 minute etch time are shown in FIG. 3A. As another non-limiting example, when a 200 nm diameter circular pattern is used, etching is accomplished for about 5 minutes to achieve the cone-shaped structures 24. Cone-shaped structures 24 formed using the 200 nm circular pattern and 5 minute etch time are shown in FIG. 3B. It is to be understood that the original geometric pattern G and/or the etching time may be further adjusted to alter the feature size (e.g., the diameter, height, etc.) of the cone-shaped structures 24. In particular, the tip 26 may become smaller and smaller as etching continues. In an embodiment, the cone-shaped structures 24 that are on the nano-scale (i.e., the largest diameter (i.e., at the base of the structure 24) is equal to or less than 1000 nm).

As illustrated in FIG. 2G, the dry etching process removes the portions of the substrate surrounding the cone-shaped structures 24, and the remainder of the substrate 14 acts as the support for the structures 24.

Referring now to FIGS. 2H and 2I and to reference numerals 108 and 110 of FIG. 1, first and second coatings 28, 30 are established on different portions P₁, P₂ of each of the structures 24. Once the coatings 28, 30 are established, one embodiment of the sensing device 10 is formed. Cross-sectional and perspective views of this embodiment of the device 10 are shown, respectively, in FIGS. 2I and 4A.

The materials for the coatings 28, 30 are selected so that each coating 28, is formed of a different material that responds differently when exposed to a predetermined external stimulus (e.g., temperature or incident light having a predetermined polarization). The first and second coatings 28, 30 may be formed of metals having different thermal expansion coefficients, or of different chalcogenide materials.

Generally, metals selected for the respective coatings 28, 30 are Raman active materials having different thermal expansion coefficients. Suitable Raman active materials include those metals whose plasma frequency falls within the visible domain, and which are not too lossy (i.e., causing undesirable attenuation or dissipation of electrical energy). The plasma frequency depends on the density of free electrons in the metal, and corresponds to the frequency of oscillation of an electron sea if the free electrons are displaced from an equilibrium spatial distribution. Non-limiting examples of such Raman active materials include noble metals such as gold, silver, platinum, and palladium, or other metals such as copper and zinc. In one non-limiting example, copper (having a thermal expansion coefficient of about 16.5 (10⁻⁶K⁻¹)) is selected for one of the coatings 28 and zinc (having a thermal expansion coefficient of about 30.2 (10⁻⁶K⁻¹)) is selected for the other of the coatings 30. In another non-limiting example, platinum (having a thermal expansion coefficient of about 8.8 (10⁻⁶K⁻¹)) is selected for one of the coatings 28 and silver (having a thermal expansion coefficient of about 18.9 (10⁻⁶K⁻¹)) is selected for the other of the coatings 30. In the non-limiting examples provided herein, the height of the structures 24 is greater than either the width or thickness, and thus linear expansion coefficients may be utilized. In other instances, it may be more desirable to deal with area expansion coefficients.

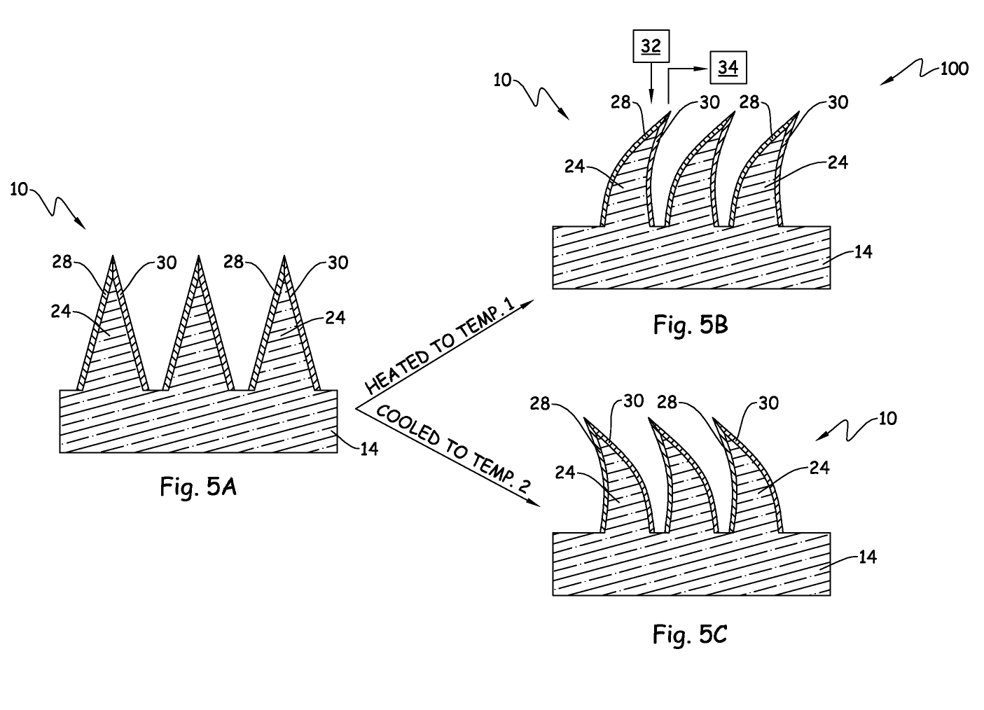

Coatings 28, 30 formed of metals with different thermal expansion coefficients render the structures 24 sensitive to temperature changes. As such, the external temperature to which the device 10 is exposed will dictate how the structures 24 are affected. The different expansions force the structure to bend one way if heated, and in the opposite direction if cooled below its normal temperature. The coating 28, 30 with the higher coefficient of thermal expansion is on the outer side of the bend curve when the structure 24 is heated and on the inner side when cooled. This particular example is discussed in reference to FIGS. 5A through 5C.

Generally, chalcogenide materials selected for the respective coatings 28, are materials that are sensitive to light with a particular polarization. Non-limiting examples of suitable chalcogenide materials include As₂S₃, Se, a-As₅₀Se₅₀, or As₄₀SₓSe₆₀₋ₓ (0≦x≦60). Coatings 28, 30 formed of different chalcogenide materials render the structures 24 sensitive to light polarization changes. As such, the polarization of the external light to which the device 10 is exposed will dictate how the structures 24 are affected (e.g., in which direction the structures 24 will bend). When exposed to light of one polarization, the coating 28 will cause the structures 24 to bend one way, and when exposed to light of another polarization, the coating 30 will cause the structures 24 to bend another way. As such, the selected materials for coatings 28, 30 will depend, at least in part, on the desired polarization sensitivities for the coatings 28, 30 in the resulting device 10.

The portions P₁, P₂ upon which the coatings 28, 30 are respectively deposited are generally opposed sides or areas of the structure 24. As shown in FIG. 21, the coating 28 is established on one area of the structure 24 and the other coating 30 is established on an opposed area of the structure 24. When the structure 24 includes multiple facets (see, e.g., FIG. 40), the coatings 28 and 30 may be deposited to facilitate the desirable physical movement (e.g., bending) of the structure 24 when it is exposed to a particular external stimulus.

In one embodiment, the coatings 28, 30 are selectively deposited on the respective desirable portions P₁, P₂ via electron beam (e-beam) evaporation, angle deposition, focused ion or electron beam induced gas injection deposition, or laser induced deposition. It is to be understood however, that other selective deposition processes may be used. The coatings 28, 30 each have a thickness ranging from about 10 nm to about 200 nm. It is to be understood that the coatings 28, 30 may overlap and/or intermingle slightly at the interface of the coatings 28, 30. Generally, one of the coatings 28, 30 is selectively established, and then another of the coatings 30, 28 is selectively established.

Referring now to FIGS. 4A through 4B, different embodiments of the environment sensing device 10, 10′, 10″ are respectively depicted. Each device 10, 10′, 10″ includes an array of the structures 24, 24′, 24″ having the different coatings thereon 28, 30. It is to be understood that any combination of coatings 28, 30 may be used in order to achieve the desirable change-in-environment induced response. As previously mentioned, the device 10 in FIG. 4A includes the cone-shaped structures 24 having coatings 20 and 30 established on opposed areas.

Referring now specifically to FIG. 4B, an example of a device 10′ including cylinder/pillar shaped structures 24′ is shown. In this embodiment, the mask 20 having the circular geometric pattern G shown in FIG. 20 may be used to form the three-dimensional cylinder shaped structures 24′. It is to be understood that such cylinder/pillar shaped structures 24′ may be formed via a method similar to that described herein in reference to FIGS. 2A through 2I, except that a more directional etching recipe is used. Coatings 28 and 30 may be selectively deposited on opposed sides (as previously described) to form the environment sensitive device 10′.

Referring now to FIG. 4C, another example of the device 10″ including pyramid shaped structures 24″ is shown. In this embodiment, a mask having a square geometric pattern G may be used to form three-dimensional pyramid shaped structures 24″. The depositing and etching techniques described herein may be utilized to form the various elements of the structure 10″, and the etching conditions may be altered to achieve the desirable structure 24″. Such pyramid shaped structures 24″ have four facets which taper to form the tip 26. The base of such structures 24″ resembles the square pattern of the mask used. Coatings 28, may be selectively deposited thereon (as previously described).

While the same coatings 28 and 30 are shown on each structure 24, 24′, 24″ in the arrays, it is to be understood that with selective deposition, each structure 24, 24′, 24″ may have different coatings 28, 30 than each other structure 24, 24′, 24″ in the array.

Referring now to FIGS. 5A through 5C, an embodiment of the device 10 is shown before (FIG. 5A) and after (FIGS. 5B and 5C) exposure to different external environments. In this embodiment, the coatings 28 and 30 are different metals having different thermal expansion coefficients, and thus the structures 24 react differently when exposed to different temperatures. In the example shown in FIGS. 5A through 5C, the coating 28 has a higher coefficient of thermal expansion than coating 30. The different expansions force the structure 24 to bend one way if heated (e.g., Temp. 1), and in the opposite direction if cooled below its normal temperature (e.g., Temp 2). The external stimulus may be applied directly to the device 10 (e.g., heat and/or light directed at the device 10), or the device 10 may be positioned in an environment in which the external stimulus is present (e.g., in an oven).

FIG. 5B illustrates the device 10 after exposure to heating. As depicted, the coating 28 having the higher coefficient of thermal expansion is on the outer side of the curve when the structure 24 is heated. Similarly, FIG. 5C illustrates the device 10 after exposure to cooling below its normal temperature. As depicted, the coating 28 having the higher coefficient of thermal expansion is on the inner side of the curve when the structure 24 is cooled.

FIG. 5B also illustrates components of a system 100 for performing Raman spectroscopy using the device 10. Such a system 100 includes the device 10, a stimulation/excitation light source 32, and a detector 34. It is to be understood that the system 100 may, in some embodiments, also include an optical component (not shown, e.g., an optical microscope), which is positioned between the light source 32 and the device 10. The optical component focuses the light from the light source 32 to a desirable area of the device 10, and then again collects the Raman scattered light and passes such scattered light to the detector 34. Analyte molecules (not shown) may be introduced across the Raman active structures 24, where they may be exposed to stimulating/excitation wavelengths from the light source 32, and the resulting signals may be detected by the Raman detection unit 34. In certain embodiments, the detector 34 may also be operably coupled to a computer (not shown) which can process, analyze, store and/or transmit data on analytes present in the sample.

The bending of the structures 24 in a particular direction enables additional control over the angle at which the stimulation/excitation light (from the source 32) contacts the structures 24. Without being bound to any theory, it is believed that directing the incident light at a particular controlled angle may, in some instances, maximize the enhancement of the SERS signal.

While several embodiments have been described in detail, it will be apparent to those skilled in the art that the disclosed embodiments may be modified. Therefore, the foregoing description is to be considered exemplary rather than limiting.

1. An environment sensitive device, comprising:
a substrate;
a three-dimensional structure established on the substrate;
a first coating established on a first portion of the three-dimensional structure; and
a second coating established on a second portion of the three-dimensional structure, the first and second coatings being different materials that are configured to respond differently when exposed to a predetermined external stimulus.

2. The environment sensitive device as defined in claim 1 wherein the predetermined external stimulus is selected from temperature and incident light having a predetermined polarization.

3. The environment sensitive device as defined in claim 1 wherein the first and second coatings are metals having different thermal expansion coefficients, or different chalcogenide materials.

4. The environment sensitive device as defined in claim 1 wherein the first coating is zinc and wherein the second coating is copper.

5. The environment sensitive device as defined in claim 1 wherein the three-dimensional structure has a shape selected from a cone shape, a cylinder shape, and a polygonal shape having at least three facets which angle toward a tip.

6. The environment sensitive device as defined in claim 1, further comprising:
a plurality of other three-dimensional structures established on the substrate;
the first coating established on a first portion of each of the plurality of three-dimensional structures; and
the second coating established on a second portion of each of the plurality of three-dimensional structures.

7. The environment sensitive device as defined in claim 6 wherein each of the three-dimensional structures is formed integrally with the substrate.

8. A method of using the environment sensitive device as defined in claim 1, the method comprising:
exposing the three-dimensional structure to the predetermined external stimulus, thereby causing the three-dimensional structure to bend in a predetermined manner; and
exposing light of an excitation wavelength to a predetermined portion of a surface of the bent three-dimensional structure at a predetermined angle with respect to the surface.

9. A temperature sensitive device, comprising:
a substrate;
a plurality of three-dimensional structures established on the substrate, each of the three-dimensional structures having a shape selected from the group consisting of a cone shape, a cylinder shape and a polygonal shape having at least three facets which angle toward a tip;
a first metal coating established on a first portion of each of the plurality of three-dimensional structures; and
a second metal coating established on a second portion of each of the plurality of three-dimensional structures, the first and second metal coatings having different thermal expansion coefficients.

10. The temperature sensitive device as defined in claim 9 wherein the first coating is zinc and wherein the second coating is copper.

11. The temperature sensitive device as defined in claim 9 wherein each of the three-dimensional structures is formed integrally with the substrate.

12. A method of making an environment sensitive device, comprising:
patterning a resist such that a geometric pattern is defined by any remaining resist, the resist being established on a support including at least a substrate;
depositing a mask layer on the patterned resist;
patterning a portion of the mask layer such that the patterned resist is removed, the geometric pattern is transferred to the mask layer, and at least one portion of the substrate is exposed;
dry etching, for a predetermined time, the exposed portion of the substrate to form a three-dimensional structure having a perimeter shape that corresponds with a shape of the geometric pattern;
selectively establishing a first coating on a first portion of the three-dimensional structure; and
selectively establishing a second coating on a second portion of the three-dimensional structure, the first and second coatings being formed of different materials that are configured to respond differently when exposed to a predetermined external stimulus.

13. The method as defined in claim 12 wherein selectively establishing the first and second coatings is accomplished via electron-beam evaporation.

14. The method as defined in claim 12, further comprising selecting the different materials for the first and second coatings so that each coating responds differently when exposed to temperature or when exposed to incident light having a predetermined polarization.

15. The method as defined in claim 12, further comprising:
patterning the resist such that a plurality of geometric patterns is defined by any remaining resist;
patterning portions of the mask layer such that the patterned resist is removed, the geometric patterns are transferred to the mask layer, and multiple portions of the substrate are exposed;
dry etching, for a predetermined time, the exposed portions of the substrate to form a plurality of three-dimensional structures, each having a perimeter shape that corresponds with a shape of one of the geometric patterns;
selectively establishing the first coating on a first portion of each of the three-dimensional structures; and
selectively establishing the second coating on a second portion of each of the three-dimensional structures.

16. The environment sensitive device as defined in claim 1 wherein at least one dimension of the three-dimensional structure is equal to or less than 200 nm.

17. The method as defined in claim 12 wherein the support further includes an insulating layer established on the substrate, and wherein the method further comprises patterning a portion of the insulating layer while the portion of the mask layer is patterned such that the geometric pattern is also transferred to the insulating layer.

18. The method as defined in claim 17 wherein during dry etching, the patterned mask and insulating layers are consumed.
